(19) United States
(12) Patent Application Publication
(10) Pub. No.: US 2014/0152428 A1
(43) Pub. Date: Jun. 5, 2014

(54) NON-SPEAKING REMINDING DEVICE USED IN GETTING OFF A PUBLIC TRANSPORTATION

(71) Applicants: Wei-Zhang Zhou, Changhua County (TW); Zi-He Zhou, Taipei City (TW)

(72) Inventors: Wei-Zhang Zhou, Changhua County (TW); Zi-He Zhou, Taipei City (TW)

(21) Appl. No.: 13/693,132

(22) Filed: Dec. 4, 2012

(51) Int. Cl. A44C 3/00; G09F 3/00; G08B 21/00; G09F 3/04

(52) U.S. Cl. CPC A44C 3/001; G09F 3/04; G09F 3/00; G08B 21/00
USPC 340/384.7; 40/299.01; 40/1.5; 40/661.02

(57) ABSTRACT

A non-speaking reminding device used in getting off a public transportation mainly comprises a mark section disposed on a displayed object which is convenient to carry at an apparent place. The mark section disposes a popular and easy understanding signified pattern. Preferably, the mark section can further combine a miniature illuminant or a sound resource. Therefore, the subject reminding device visually reminds other people without speaking that the user is going to get off a vehicle, which renders other people able to displace their positions automatically and create an unobstructed passage for the user to pass and get off the vehicle quickly.

### BACKGROUND OF THE INVENTION

1. Field of the Invention

The present invention relates to a non-speaking reminding device used in getting off a public transportation, particularly to a reminding device showing to other people an intention that users are ready to get off a vehicle. The popular and easy understanding signified pattern on the mark section is disposed on the personal stuff for other people to understand, cooperate, and achieve reminding without speaking.

2. Description of the Related Art

Taking a public transportation is cheap, convenient, and meaningful for reducing the air pollution caused by car exhaust and solving the traffic jam. The percentage of taking the public transportation applied in the metropolis gets higher.

Due to the passengers are gradually increased, the over-crowded condition is often appeared in the paths of the vehicles or compartments which are jammed by the passengers during the traffic peak. A passenger who is moving to the exit earlier and get off the vehicle at the next stop must orally remind the people blocking at the front one by one. In a moving vehicle or a crowded compartment, the passenger must remind other people by lifting up the volume or even touching their body. Therefore, people who are reminded are usually scared or displeased, which even causes the misunderstanding, dispute, and conflict.

On the free-speaking native public transportation, the foregoing ways of reminding people by speaking or body touching have their applicability, and many people are unable to get off the bus in time since they are too late to move to the exit before arriving at the next stop. On the foreign public transportation, whether the expression is clear and appropriate, or the understanding of other people is understandable, it may cause the inconvenience and disadvantage when taking a public transportation in foreign countries.

### SUMMARY OF THE INVENTION

It is therefore the main purpose of this invention to provide a non-speaking reminding device used in getting off a public transportation that has a mark section disposed on a displayed object which is convenient to carry at an apparent place. A popular and easy understanding signified pattern is disposed on the mark section, thereby achieving the expression without any oral reminding and properly showing the intention of the user to other people that the user is going to get off the vehicle, which renders other people able to understand and displace their positions automatically for attaining a simply and directly reminding effect and allowing the user to get off the vehicle in time.

The second purpose of this invention still provides a non-speaking reminding device used in getting off a public transportation that renders other people understand and displace their positions automatically, thus avoiding scaring other people or causing unnecessary disadvantages like unhappiness and misunderstanding. Therefore, the harmoniousness of taking a public transportation is enhanced.

The third purpose of this invention still provides a non-speaking reminding device used in getting off a public transportation that solves the language difficulties by disposing a popular and easy understanding signified pattern on a mark section which renders other people easily understand the user's intention and displace their positions automatically, thereby avoiding the inappropriate language expression or misunderstanding. Furthermore, it is applicable for all the passengers of the public transportation in different countries.

The last purpose of this invention still provides a non-speaking reminding device used in getting off a public transportation, wherein, a mark section with a popular and easy understanding signified pattern is disposed. Preferably, the invention can further combined with a miniature illuminant or a miniature sound resource when necessary, thereby increasing or attracting other people's attention beforehand on the premise that the people are scared or made unhappy, therefore achieving the visual attraction of understanding the intention expression of the signified pattern for a better beneficial result.

### BRIEF DESCRIPTION OF THE DRAWINGS

FIG. 1 is a schematic view showing a first preferred embodiment of the present invention;

FIG. 1-A is a first schematic view showing the first preferred embodiment of the present invention in FIG. 1;

FIG. 1-B is a second schematic view showing the first preferred embodiment of the present invention in FIG. 1;

FIG. 2 is a schematic view showing a second preferred embodiment of the present invention;

FIG. 2-A is a first schematic view showing the second preferred embodiment of the present invention in FIG. 2;

FIG. 2-B is a second schematic view showing the second preferred embodiment of the present invention in FIG. 2; and

FIG. 3 is a schematic view showing the present invention in use.

### DETAILED DESCRIPTION OF THE PREFERRED EMBODIMENTS

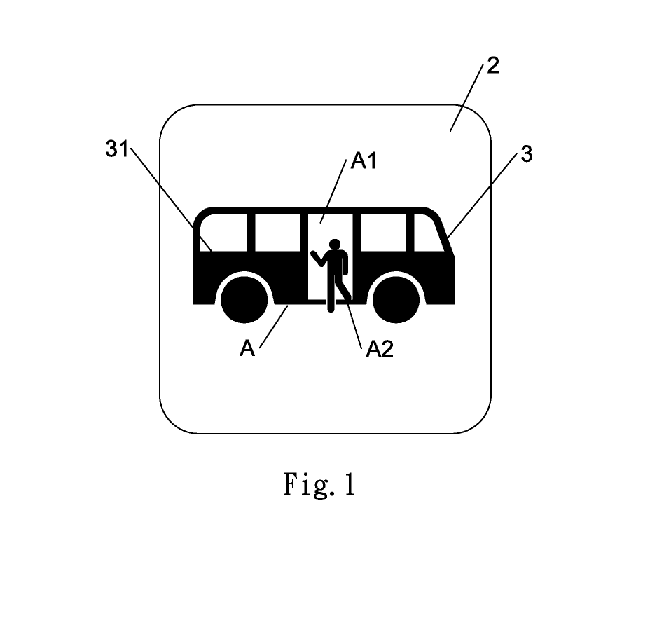

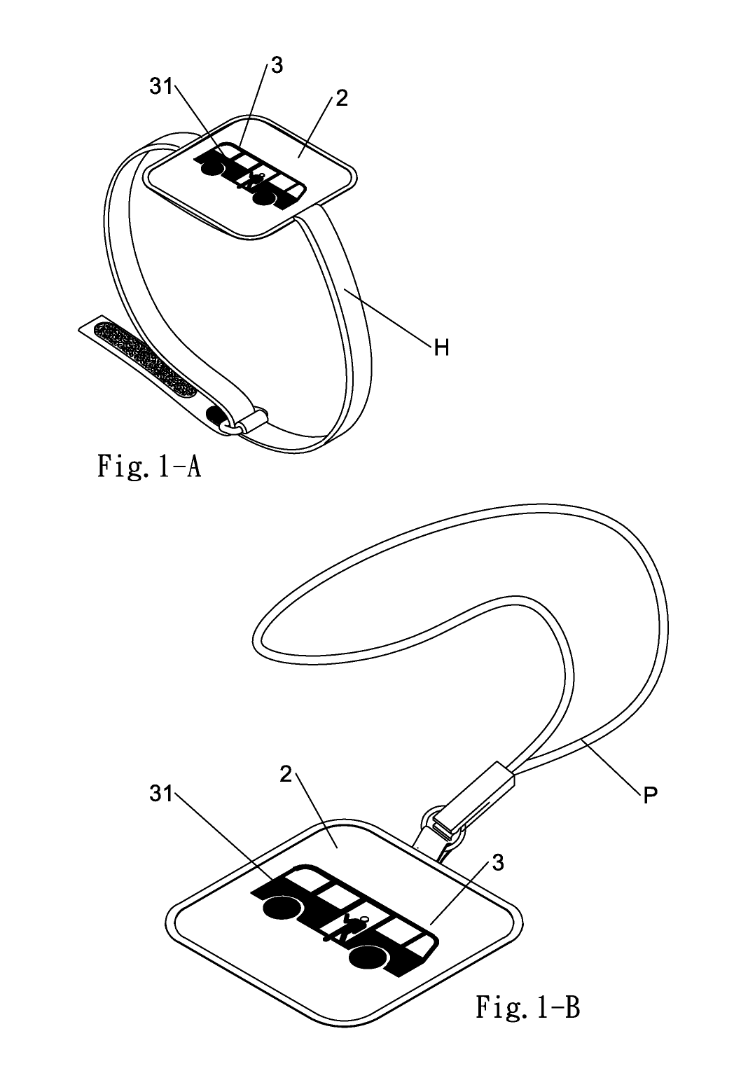

Referring to FIG. 1, the present invention is shown. A non-speaking reminding device used in getting off a public transportation comprises a displayed object 2 being convenient for users to carry at an apparent place. The object 2 is able to combine with a bracelet H that puts on the wrist (or a loop as shown in FIG. 1-A) or a removable ribbon P (as shown in FIG. 1-B) as a preferred embodiment of the present invention. Wherein:

A mark section 3 is disposed on the displayed object 2. The mark section 3 is either fixed on the displayed object 2 or temporarily attached to the displayed object 2 via a lamination adhering form. A signified pattern 31 formed by a printing or an embroidering is disposed on a front side of the mark section 2;

The signified pattern 31 is not confined to one pattern but able to be a popular and easy understanding symbol or any kind of design chart that shows the intention that the user is going to get off a vehicle. The signified pattern 31 has the following effects as shown in FIG. 1 and other figures:

The pattern 31 is defined as a vehicle A that represents a public transportation (such as cars, trains, and rapid transit, etc.). A passenger A2 walks out of a car door A1, which shows the intention that the passenger namely the user is going to get off the vehicle.

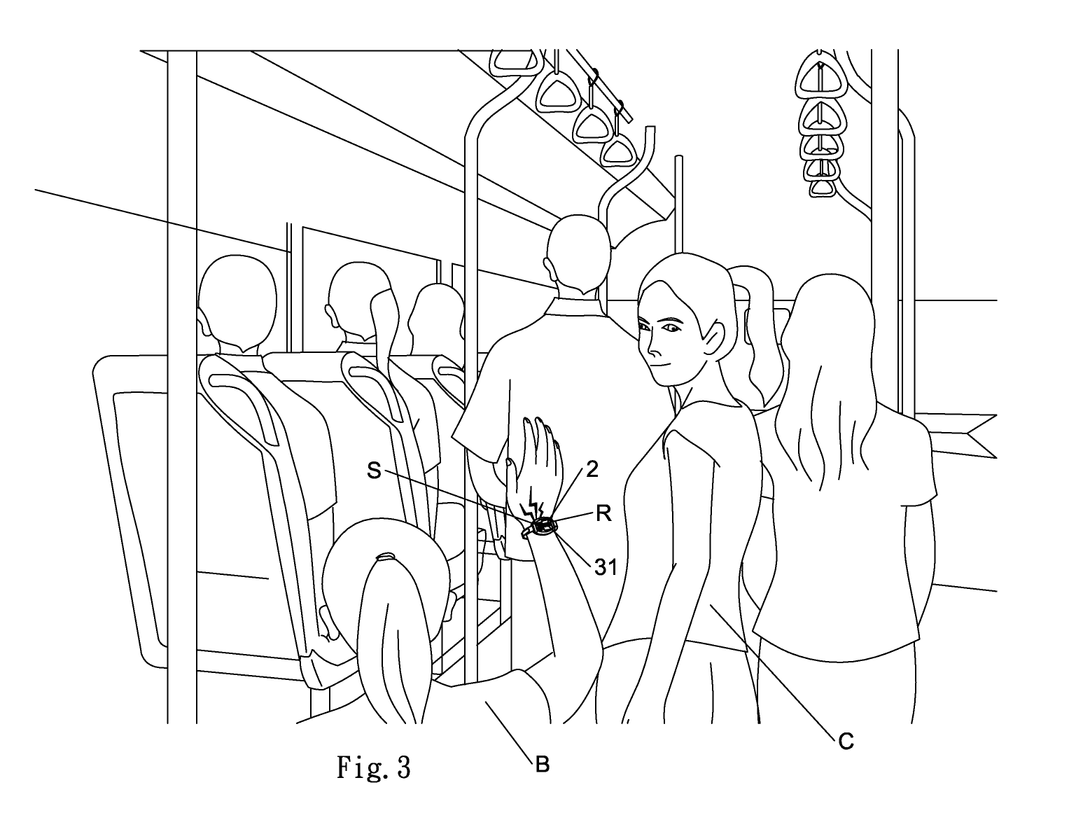

Referring to FIG. 3, when the user B shows the displayed object 2 (referring to FIG. 1, when the user raises a hand with the displayed object 2 putting thereon), the signified pattern 31 is shown in front of other passengers' C sights, whereby other people become conscious of the user's intention and displace their positions automatically, so as to create an unobstructed passage for the user to pass and get off the vehicle quickly and without any oral reminding.

Due to the displayed object 2 provided with the signified pattern 31 is set as an easy-wearing or an easy-taking-off personal stuff, the displayed object 2 or the signified pattern 31 is able to be stored or hidden in order to prevent the misunderstanding of other passengers C beside the user when the user is not ready to get off the vehicle. The displayed object is only taken when the user prepares to get off the vehicle. Therefore, the displayed object 2 can also be set as a personal stuff, such as a hat, a scarf, or a hanging name plate.

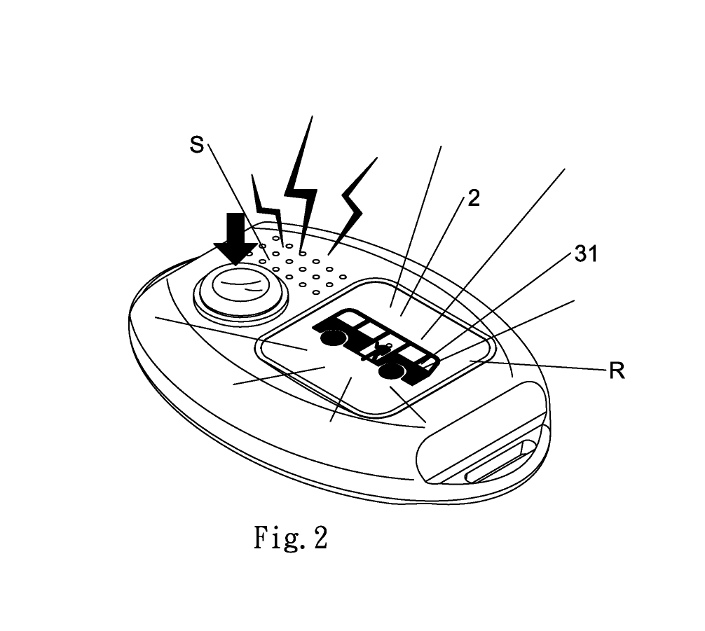

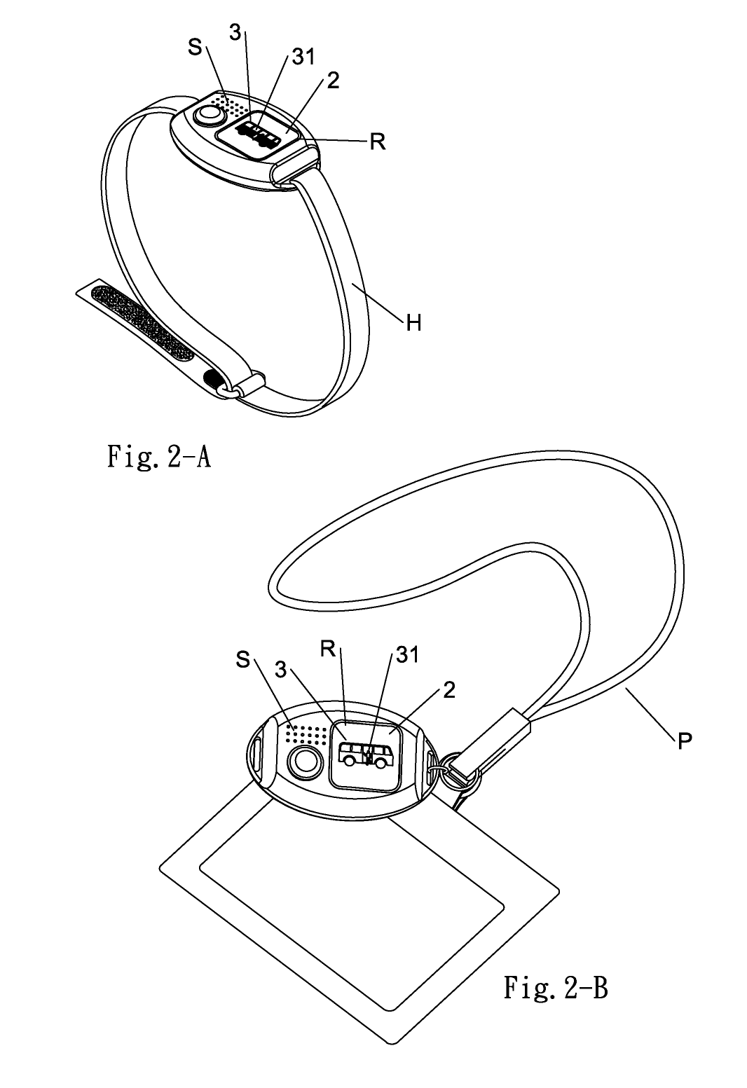

Referring to FIGS. 2, 2-A, 2-B, and 3 are shown. The mark section 3 on which the signified pattern 31 is disposed combines either with a miniature illuminant like an LED light R (or a fluorescent agent) which attracts other passengers' C attention and recognizes the intention of the signified pattern 31 by a bit of visual irritant, such as enhancement or twinkle of the brightness on the premise that other people are scared or made unhappy, or with a miniature sound resource S which also attracts other passengers' C attention and recognizes the intention of the signified pattern 31 by a bit of audio irritant, such as a short beep sound of a pocket timekeeper.

To sum up, the present invention provides an extensive and popular reminding device used in getting off a vehicle. Passengers who take a public transportation have a backup when one of them shows the reminding device, so other passengers standing beside are able to recognize the intention of the user who prepares himself to get off the vehicle and automatically move for creating a passage. The present invention enhances the peace in taking a public transportation by forming such a common consensus. Moreover, the present invention attains the practicability and benefits of easy carrying and easy using. It is believed that the present invention conforms to the patentability of the patent regulation.

I claim:

1. A non-speaking reminding device used in getting off a public transportation mainly comprising a displayed object being convenient for users to put on or wear at an apparent place;
wherein a mark section is disposed on said displayed object; a signified pattern formed by printing or embroidering is disposed on a front side of said mark section; a pattern of said signified pattern is a popular and easy understanding symbol or a design chart for achieving an expression that users are ready to get off said public transportation, by showing said displayed object of users to others, said displayed object provides a visual reminder for others to become conscious that said users are going to get off said public transportation and move to other positions automatically for a convenience of getting off said public transportation.

2. The non-speaking reminding device used in getting off a public transportation as claimed in claim 1, wherein said displayed object is a bracelet, a loop, or a removable ribbon that are able to put on a wrist; or said displayed object is a personal stuff like a hat, a scarf, or a hanging name plate.

3. The non-speaking reminding device used in getting off a public transportation as claimed in claim 1, wherein said signified pattern disposed on said front side of said mark section is formed by printing or embroidering.

4. The non-speaking reminding device used in getting off a public transportation as claimed in claim 1, wherein said mark section is either fixed on said displayed object or temporarily attached to said displayed object via a lamination adhering form.

5. The non-speaking reminding device used in getting off a public transportation as claimed in claim 1, wherein said mark section on which said signified pattern is disposed combines a miniature illuminant, like an LED light or a fluorescent agent.

6. The non-speaking reminding device used in getting off a public transportation as claimed in claim 1, wherein said mark section on which said signified pattern is disposed combines a miniature sound resource, such as a short beep sound of a pocket timekeeper.
